(19) United States
(12) Patent Application Publication
(10) Pub. No.: US 2026/0145735 A1
(43) Pub. Date: May 28, 2026

(54) Device and Method for Checking an Accelerometer in a Steering System, the Vehicle Comprising the Device

(71) Applicant: Robert Bosch GmbH, Stuttgart (DE)

(72) Inventors: Akshay Cariappa Panathale Nandakumar, Schorndorf-Weiler (DE); Florian Bader, Crailsheim (DE); Thomas Wanner, Rudersberg (DE); Tobias Abele, Moegglingen (DE); Wadim Okley, Leinzell (DE)

(21) Appl. No.: 19/398,947

(22) Filed: Nov. 24, 2025

(30) Foreign Application Priority Data
Nov. 26, 2024 (DE) 10 2024 211 293.3

(51) Int. Cl. B62D 6/00

(52) U.S. Cl. CPC B62D 6/005

(57) ABSTRACT

In a method for checking an accelerometer in a steering system, which includes an electromechanical steering actuator having an accelerometer that is configured to measure a first acceleration value on a first axis, a second acceleration value on a second axis, and a third acceleration value on a third axis, all three of which are perpendicular to each other, the method includes determining whether the vehicle is stationary or driving. The method further includes, while stationary, determining a correct output of the first acceleration value and the second acceleration value and the third acceleration value depending on the first acceleration value measured by the accelerometer while stationary, the second acceleration value measured by the accelerometer while stationary, and the third acceleration value measured by the accelerometer while stationary.

This application claims priority under 35 U.S.C. § 119 to application no. DE 10 2024 211 293.3, filed on Nov. 26, 2024 in Germany, the disclosure of which is incorporated herein by reference in its entirety.

### BACKGROUND

The disclosure relates to a device and method for checking an accelerometer in a steering system and a vehicle comprising the device.

In a steering system for a vehicle, an operator element is connected to an electromechanical actuator.

### SUMMARY

A method for checking an accelerometer in a steering system, wherein the steering system comprises an electromechanical steering actuator, wherein the electromechanical steering actuator comprises an accelerometer, wherein the accelerometer is configured to measure a first acceleration value on a first axis, a second acceleration value on a second axis and a third acceleration value on a third axis, wherein the axes are perpendicular to each other, wherein it is determined whether the vehicle is stationary or driving, wherein, while stationary, a correct output of the first acceleration value and the second acceleration value and the third acceleration value is determined depending on the first acceleration value measured by the accelerometer while stationary, the second acceleration value measured by the accelerometer while stationary, and the third acceleration value measured by the accelerometer while stationary. In addition to the described checking, further validation while driving and by matching another accelerometer in the vehicle (ESP, airbag, etc.) is provided. This will allow for a check to achieve the objectives from SG_TLSR_05 and SG_TLSR_06 (ASIL-D) as per ASIL-B.

It may be contemplated that, while driving, a correct output of the third acceleration value is determined depending on the third acceleration value measured by the accelerometer while driving and depending on a lateral acceleration of the vehicle measured while driving, and wherein, while driving, a correct output of the first acceleration value and second acceleration value is determined depending on the first acceleration value measured while driving and depending on the second acceleration value measured while driving and depending on a longitudinal acceleration measured while driving or a longitudinal acceleration of the vehicle determined from a vehicle speed.

While stationary, for example, the correct output of the first acceleration value and the second acceleration value and the third acceleration value is determined, when it is determined that the root of the square sum of the first acceleration value measured by the accelerometer while stationary, the second acceleration value measured by the accelerometer while stationary and the third acceleration value measured by the accelerometer while stationary is within a predetermined tolerance, in particular 10%, by a predetermined value, in particular 1 g. This represents a way to reliably check the function of the accelerometer while stationary.

It may be contemplated that the steering system comprises an electromechanical steering actuator, wherein the steering actuator comprises an engine for controlling the steering actuator, the engine comprising a rotor, wherein, when stationary, the correct output of the first acceleration value, the second acceleration value, and the third acceleration value is determined, when it is determined that the speed of the rotor is less than or equal to a predetermined speed, particularly equal to zero. That is, the accelerometer is checked when the steering actuator and the vehicle are stationary.

The standstill is determined, for example, when the speed of the vehicle is less than or equal to a predetermined speed, in particular equal to zero.

The correct output of the third acceleration value is determined, when it is determined that the third acceleration value is greater than a limit value for the third acceleration value, in particular 0.2 g, and the measured lateral acceleration of the vehicle is greater than a limit value for the lateral acceleration, in particular 0.2 g, and when it is determined (314) that the difference between the lateral acceleration and the third acceleration value is smaller in magnitude than a limit value for the difference, in particular 0.05 g. This represents one way to reliably check the function of the third acceleration value of the accelerometer while driving.

The correct output of the third acceleration value is determined, for example, when it is determined that an average of a predetermined number of differences of lateral acceleration of the vehicle and third acceleration value measured simultaneously during driving is less than the limit value for the difference. This represents a way to make the check robust against non-critical malfunctions.

In one example, a total acceleration value is determined depending on the first acceleration value measured while driving and the second acceleration value measured while driving, wherein the correct output of the acceleration amount or value is determined in the direction of the longitudinal acceleration, when it is determined that the total acceleration value is greater than a limit value for the total acceleration value, in particular 0.15 g, and the longitudinal acceleration is greater than a limit value for the longitudinal acceleration, in particular 0.15 g, and when it is determined that the difference between the longitudinal acceleration and the total acceleration value is smaller in magnitude than a limit value for the difference, in particular 0.05 g. This represents a way to reliably check the correct detection of the first and the second acceleration values when driving.

It may be contemplated that the correct output of the first and second acceleration value is determined, when it is determined that an average of a predetermined number of differences of simultaneously measured longitudinal accelerations and determined total acceleration values while driving is less than the limit value for the difference. This represents a way to make the check robust against non-critical malfunctions.

It may be contemplated that a total acceleration value is determined depending on the first acceleration value measured while driving and the second acceleration value measured while driving, wherein a vehicle longitudinal acceleration is determined depending on the speed of the vehicle, wherein the correct output of the total acceleration determined from the first and second acceleration values is determined, when it is determined that the total acceleration value is greater than a limit value for the total acceleration value, in particular 0.1 g, and the vehicle longitudinal acceleration is greater than a limit value for the vehicle longitudinal acceleration, in particular 0.1 g, and when it is determined that the difference between the vehicle longitudinal acceleration and the total acceleration value is smaller in magnitude than a limit value for the difference, in particular 0.05 g. This represents a way to reliably check the function of the first and the second acceleration values while driving.

The correct output of the first and second acceleration value is determined, for example, when it is determined that an average of a predetermined number of differences of simultaneously occurring vehicle accelerations and total acceleration values while driving is less than the limit value for the difference. This represents a way to make the check robust against non-critical malfunctions.

A device for checking an accelerometer in a steering system, wherein the steering system comprises an electromechanical steering actuator, wherein the electromechanical steering actuator comprises an accelerometer, wherein the accelerometer is configured to measure a first acceleration value on a first axis, a second acceleration value on a second axis and a third acceleration value on a third axis, wherein the axes are perpendicular to each other, and the device is configured to execute the method. The installed accelerometer uses its own sensor coordinate system, which has a different orientation compared to the vehicle coordinate system.

A vehicle may be provided wherein the vehicle comprises a steering system, wherein the steering system comprises an electromechanical steering actuator, wherein the electromechanical steering actuator comprises an accelerometer, wherein the accelerometer is configured to measure a first acceleration value on a first axis, a second acceleration value on a second axis, and a third acceleration value on a third axis, wherein the axes are perpendicular to each other, and wherein the vehicle comprises the device.

### BRIEF DESCRIPTION OF THE DRAWINGS

Further advantageous embodiments will become apparent from the following description and the drawing. The drawings show:

FIG. 1 a vehicle;

FIG. 2 a flow chart of a first portion of a method for checking an accelerometer in a steering system of the vehicle,

FIG. 3 a flow chart of a second portion of the method,

FIG. 4 a flow chart of a third portion of the method,

FIG. 5 a flow chart of a fourth portion of the method.

### DETAILED DESCRIPTION

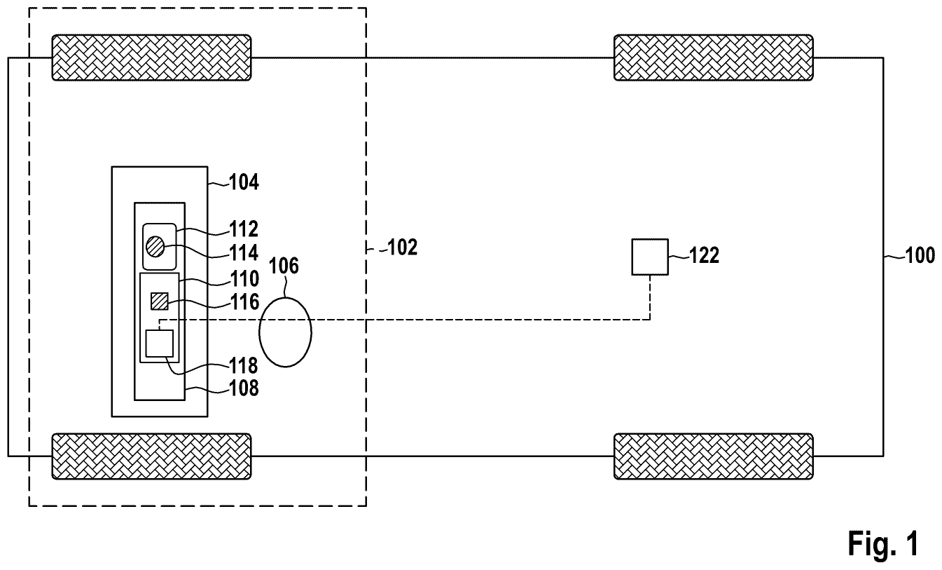

A vehicle 100 is shown schematically in FIG. 1.

The vehicle 100 comprises a steering system 102.

In particular, the steering system 102 includes an electromechanical steering actuator 104 and an operator element 106. In the example, the operator element 106 is a steering wheel. A joystick may also be provided as an operator element 106.

The steering system 102, in particular the electromechanical steering actuator 104, includes the accelerometer 116.

In the example, the steering system 102 includes a printed circuit board 108 having an electronic circuit 110 for controlling the steering actuator 104. The accelerometer 116 in the example is arranged on the printed circuit board 108. The accelerometer 116 may also be arranged on a housing or other component of the steering system 102, in particular of the electromechanical steering actuator 104.

The accelerometer 116 is configured to output a first acceleration value, a second acceleration value, and a third acceleration value.

In the example, the accelerometer 116 is associated with an x-axis, a y-axis, and a z-axis. The x-axis is associated with the first acceleration value. The y-axis is associated with the second acceleration value. The z-axis is associated with the third acceleration value.

The accelerometer 116 is configured to measure the first acceleration value in the direction of the x-axis. The accelerometer 116 is configured to measure the second acceleration value in the direction of the y-axis. The accelerometer 116 is configured to measure the third acceleration value in the direction of the z-axis. The sensor uses its own coordinate system, which has a different orientation than the vehicle coordinate system.

The vehicle 100 includes a device 118 for checking the accelerometer 116. In the example, the electronic circuit 110 includes the device 118.

The steering actuator 104 includes a motor 112 for controlling the steering actuator 104.

The motor 112 comprises a rotor 114.

The device 118 is configured to sense the speed of the rotor 114.

In the example, the electronic circuit 110 is configured to control the motor 112. In the example, the electronic circuit 110 senses the speed of the rotor 114.

The vehicle 100 includes a further accelerometer 120. The further accelerometer 120 is configured to sense and output a longitudinal acceleration and a lateral acceleration of the vehicle 100.

The further accelerometer 120 is, for example, a sensor provided for an electronic stability program, airbag system, etc. in the vehicle 100.

The device 118 is configured to process the longitudinal acceleration and the lateral acceleration via a communication link 122 from the further accelerometer 120.

In the example, the electronic circuit 110 is configured to receive the longitudinal acceleration and the lateral acceleration via the communication link 122 from the further accelerometer 120.

The device 118 is configured to perform a method of checking the accelerometer 116.

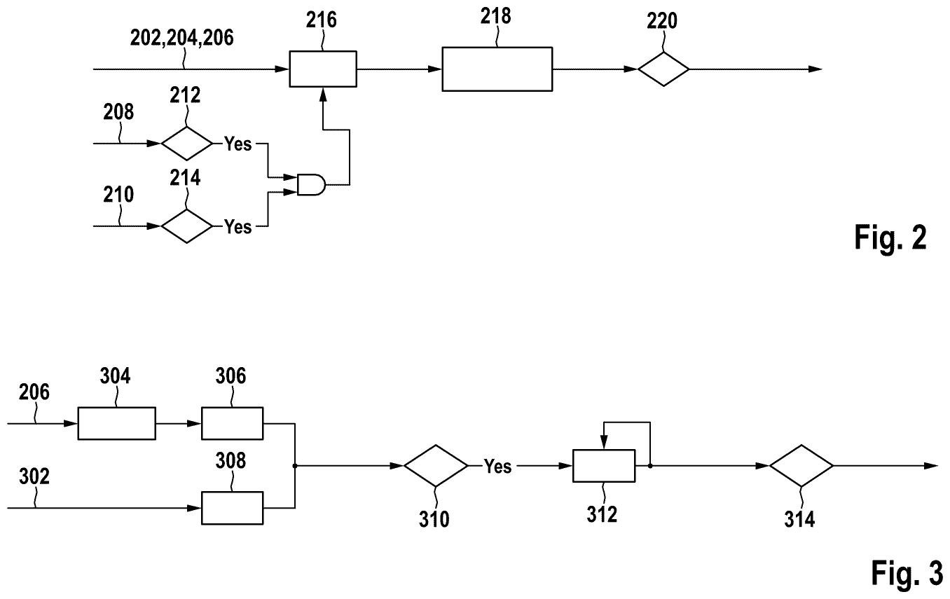

FIG. 2 shows a flow chart of a first portion of a method for checking an accelerometer 116.

The first portion of the method is performed while the vehicle 100 is stationary.

The first portion of the method is based on a first acceleration value 202 measured by the accelerometer 116 while stationary, a second acceleration value 204 measured by the accelerometer 116, and a third acceleration value 206 measured by the accelerometer 116 while stationary.

The first portion of the method is based on the speed 208 of the vehicle 100 and the rotational speed 210 of the rotor 114.

In a step 212, it is checked whether the vehicle 100 is stationary or not. In the example, it is determined that the vehicle 100 is stationary when the speed 208 of the vehicle 100 is less than or equal to a predetermined speed, particularly equal to zero.

In a step 214, it is checked whether the steering actuator 104 is stationary or not. In the example, it is determined that the steering actuator 104 is stationary if the rotational speed 210 is less than or equal to a predetermined rotational speed, particularly equal to zero.

When it is determined that the vehicle 100 is stationary and the steering actuator 104 is stationary, a step 216 is performed. Otherwise, the method is terminated.

That is, the check is only started in the first portion when the vehicle 100 and the steering actuator 104 are stationary.

At step 216, the check of the accelerometer 116 is started.

At step 216, the first acceleration value 202, the second acceleration value 204, and the third acceleration value 206 are sensed.

Subsequently, a step 218 is carried out.

At step 218, a result r is determined depending on the root of the square sum of the sensed first acceleration value 202 of the sensed second acceleration value 204 and the sensed third acceleration value 206. For example, the result is determined using the formula listed,

$$r = \sqrt{{x}^{2} + {y}^{2} + {z}^{2}}$$

wherein x represents the sensed first acceleration value 202, y represents the sensed second acceleration value 204 and z represents the sensed third acceleration value 206.

Subsequently, a step 220 is carried out.

In step 220, it is checked whether the result r is within a predetermined tolerance t, in particular t=10%, by a predetermined value w, in particular w=1 g.

If the result r is within the tolerance t by the predetermined value w, a correct output of the first acceleration value 202, the second acceleration value 204, and the third acceleration value 206 is determined. Otherwise, the correct output will not be determined.

That is, while stationary, the correct output of the first acceleration value 202, the second acceleration value 204, and the third acceleration value 206 is determined depending on the first acceleration value 202 measured by the accelerometer 116, the second acceleration value 204 measured by the accelerometer 116 while stationary, and the third acceleration value 206 measured by the accelerometer 116 while stationary.

FIG. 3 shows a flow chart of the second portion of the method.

The second portion of the method is performed while the vehicle is driving.

The second portion of the method is based on the third acceleration value 206 and the lateral acceleration 302 of the vehicle 100 measured by the further accelerometer 120.

The second portion optionally includes a step 304.

In the optional step 304, the third acceleration value 206 is filtered.

The second portion optionally includes a step 306.

In the optional step 306, when the step 304 is performed, the filtered third acceleration value, and otherwise the third acceleration value 206, is sampled to 100 Hz.

The second portion optionally includes a step 308.

In the optional step 308, the lateral acceleration 302 is filtered.

The second part comprises a step 310.

In step 310, it is checked whether the third acceleration value 206 is greater than a limit value for the third acceleration value, in particular 0.2 g.

In step 310, it is checked whether the lateral acceleration 302 is greater than a limit value for the lateral acceleration 302, in particular 0.2 g.

If it is determined that the third acceleration value 206 is greater than the limit value for the third acceleration value 206, and that the lateral acceleration 302 is greater than the limit value for the lateral acceleration 302, a step 312 is performed.

Otherwise, the method is terminated.

If the optional step 304 is performed, it is checked whether the filtered third acceleration value is greater than the limit value. If the optional step 306 is performed, it is checked whether the sampled third acceleration value is greater than the limit value. If the optional steps 304 and 306 are performed, it is checked whether the sampled and filtered third acceleration value is greater than the limit value.

If the optional step 308 is performed, it is checked whether the filtered lateral acceleration is greater than the limit value.

In step 312, a difference between the lateral acceleration 302 and the third acceleration value 206 is determined. In the example, the difference is determined for a predetermined number n of sensed lateral accelerations 302 and third acceleration values 206. In the example, an average of the difference for the predetermined number n of differences is determined.

When the predetermined number n is reached, a step 314 is performed.

In step 314, it is checked whether the average is less than a limit value for the difference, in particular 0.05 g.

If the average is smaller in magnitude than a limit value for the difference, the correct output of the third acceleration value 206 is determined. Otherwise, the correct output of the third acceleration value 206 is not determined.

That is, while driving, the correct output of the third acceleration value 206 is determined depending on the third acceleration value 206 measured by the accelerometer 116 while driving and depending on a lateral acceleration 302 of the vehicle 100 measured while driving, particularly simultaneously.

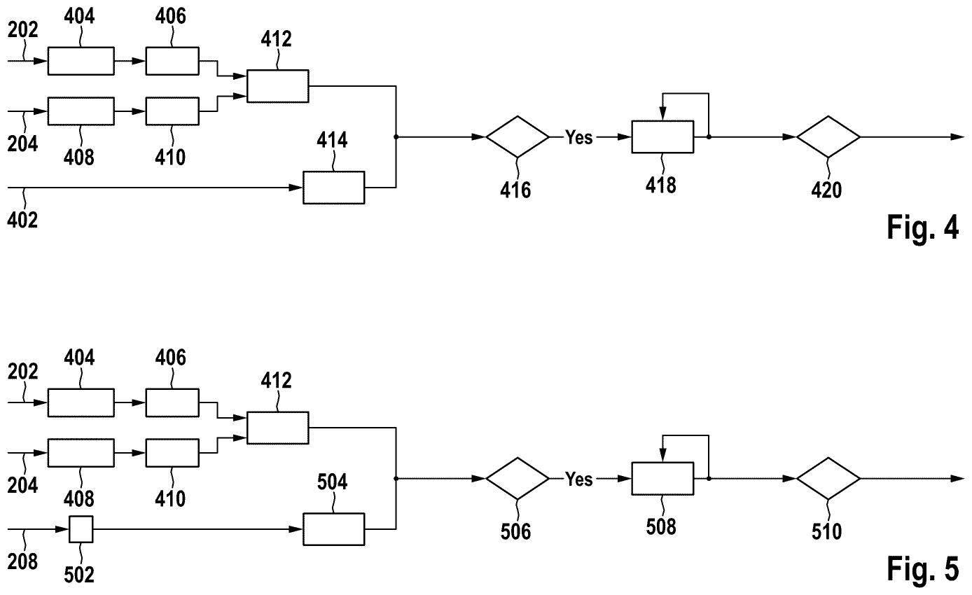

FIG. 4 shows a flow chart of the third part of the method.

The third part of the method is performed while the vehicle is driving.

The third part of the method is based on the first acceleration value 202, the second acceleration value 204, and the longitudinal acceleration 402 of the vehicle 100 measured by the further accelerometer 120.

The third portion optionally includes a step 404.

In the optional step 404, the first acceleration value 204 is filtered.

The third portion optionally includes a step 406.

In the optional step 406, when step 404 is performed, the filtered acceleration value, and otherwise the first acceleration value 202, is sampled to 100 Hz.

The third portion optionally includes a step 408.

In the optional step 408, the second acceleration value 204 is filtered.

The third portion optionally includes a step 410.

In the optional step 410, when the step 408 is performed, the filtered second acceleration value, and otherwise the second acceleration value 204, is sampled to 100 Hz.

The third portion comprises a step 412.

In step 412, a total acceleration value is determined in the direction of the longitudinal acceleration of the vehicle, depending on the first acceleration value 202 and the second acceleration value 204.

For example, the total acceleration value is the result of a vectorial addition of the first acceleration value 202 and the second acceleration value 204.

If the optional step 404 is performed, the total acceleration value is determined depending on the filtered first acceleration value. If the optional step 406 is performed, the total acceleration value is determined depending on the sampled first acceleration value. If the optional steps 404 and 406 are performed, the total acceleration value is determined depending on the sampled and filtered first acceleration value. Likewise, this applies to steps 408 and 410 relating to the second acceleration.

The third portion optionally includes a step 414.

In the optional step 414, the longitudinal acceleration 402 is filtered.

The second portion includes a step 416.

In step 416, it is checked whether the total acceleration value is greater than a limit value for the total acceleration value, in particular 0.15 g.

In step 416, it is checked whether the longitudinal acceleration 402 is greater than a limit value for the longitudinal acceleration 402, in particular 0.15 g.

If the total acceleration value is determined to be greater than the limit value for the total acceleration value, and the longitudinal acceleration 402 is determined to be greater than the longitudinal acceleration boundary value 402, a step 418 is performed.

Otherwise, the method is terminated.

If the optional step 414 is performed, it is checked whether the filtered longitudinal acceleration is greater than the limit value.

In step 418, a difference between the longitudinal acceleration 402 and the total acceleration value is determined. In the example, the difference is determined for a predetermined number n of sensed longitudinal accelerations 402 and total acceleration values. In the example, an average of the difference for the predetermined number n of differences is determined.

If the optional step 414 is performed, the difference is determined with the filtered longitudinal acceleration.

When the predetermined number n is reached, a step 420 is performed.

In step 420, it is checked whether the average is less than a limit value for the difference, in particular 0.05 g.

If the average is smaller in magnitude than a limit value for the difference, the correct output of the first acceleration value 202 and the second acceleration value 204 is determined by the determined total acceleration. Otherwise, the correct output of the first acceleration value 202 and the second acceleration value 204 is not determined.

That is, while driving, the correct output of the first acceleration value 202 and the second acceleration value 204 is determined depending on the first acceleration value 202 measured while driving and depending on the second acceleration value 204 measured while driving, and depending on the in particular simultaneously with the measured longitudinal acceleration 402 of the vehicle 100 while driving.

FIG. 5 shows a flow chart of a fourth portion of the method.

The fourth portion of the method is based on the first acceleration value 202, the second acceleration value 204, and the vehicle speed 208.

In the fourth part, the total acceleration is determined as described for the third portion.

The fourth portion includes a step 502.

In step 502, a vehicle longitudinal acceleration is determined depending on the speed 208.

The fourth portion includes an optional step 504.

In the optional step 504, the vehicle longitudinal acceleration is filtered.

The fourth portion includes a step 506.

In step 506, it is checked whether the total acceleration value is greater than a limit value for the total acceleration value, in particular 0.1 g.

In step 506, it is checked whether the vehicle longitudinal acceleration is greater than a limit value for the vehicle longitudinal acceleration, in particular 0.1 g.

If the total acceleration value is determined to be greater than the limit value for the total acceleration value, and the vehicle longitudinal acceleration is determined to be greater than the limit value of the vehicle longitudinal acceleration, a step 508 is performed.

Otherwise, the method is terminated.

If the optional step 504 is performed, it is checked whether the filtered vehicle longitudinal acceleration is greater than the limit value.

In step 508, a difference between the vehicle longitudinal acceleration and the total acceleration value is determined. In the example, the difference is determined for a predetermined number n of sensed vehicle longitudinal accelerations and total acceleration values. In the example, an average of the difference for the predetermined number n of differences is determined.

If the optional step 504 is performed, the difference is determined with the filtered vehicle longitudinal acceleration.

When the predetermined number n is reached, a step 510 is performed.

In step 510, it is checked whether the average is smaller in magnitude than a limit value for the difference, in particular 0.05 g.

If the average is smaller in magnitude than a limit value for the difference, the correct output of the first acceleration value 202 and the second acceleration value 204 is determined by the determined total acceleration. Otherwise, the correct output of the first acceleration value 202 and the second acceleration value 204 is not determined.

That is, while driving, the correct output of the first acceleration value 202 is determined depending on the first acceleration value 202 measured during driving and depending on the second acceleration value 204 measured during driving, and depending on the speed 208 of the vehicle 100 measured during driving.

1. A method for checking an accelerometer in a steering system of a vehicle, the steering system including an electromechanical steering actuator that has an accelerometer configured to measure a first acceleration value on a first axis, a second acceleration value on a second axis, and a third acceleration value on a third axis, the first, second, and third axes being perpendicular to each other, the method comprising:
determining whether the vehicle is stationary or driving; and
while stationary, determining a first correct output of the first acceleration value, a second correct output of the second acceleration value, and a third correct output of the third acceleration value depending on the first acceleration value measured by the accelerometer while stationary, the second acceleration value measured by the accelerometer while stationary, and the third acceleration value measured by the accelerometer while stationary.

2. The method according to claim 1, further comprising, while driving:
determining the third correct output of the third acceleration value depending on a measured third acceleration value measured by the accelerometer while driving and depending on a measured lateral acceleration of the vehicle measured while driving; and
determining the first correct output of the first acceleration value and the second correct output of the second acceleration value depending on:
a measured first acceleration value measured while driving;
a measured second acceleration value measured while driving; and
a measured longitudinal acceleration measured while driving or a determined longitudinal acceleration of the vehicle determined from a vehicle speed.

3. The method according to claim 1, further comprising:
while stationary, determining the first, second, and third correct outputs in response to determining that a root of a square sum of the first acceleration value measured by the accelerometer while stationary, the second acceleration value measured by the accelerometer while stationary, and the third acceleration value measured by the accelerometer while stationary is within a predetermined tolerance of a predetermined value.

4. The method according to claim 3, wherein the predetermined tolerance is 10%, and the predetermined value is 1 g.

5. The method according to claim 1, wherein:
the steering system comprises a steering actuator, which comprises a motor for controlling the steering actuator, the motor including a rotor,
while stationary, the first, second, and third correct outputs are determined in response to determining that a speed of the rotor is less than or equal to a predetermined speed.

6. The method according to claim 5, wherein the predetermined speed is zero.

7. The method according to claim 1, wherein a standstill is determined when a speed of the vehicle is less than or equal to a predetermined speed.

8. The method according to claim 7, wherein the predetermined speed is zero.

9. The method according to claim 1, wherein the third correct output is determined in response to determining that:
the third acceleration value is greater than a limit for the third acceleration value;
a measured lateral acceleration of the vehicle is greater than a limit value for the lateral acceleration; and
a difference between the lateral acceleration and the third acceleration value is smaller in magnitude than a limit value for the difference.

10. The method according to claim 9, wherein the third correct output is determined in response to determining that an average of a predetermined number of differences from simultaneously measured lateral acceleration of the vehicle and third acceleration values during driving is determined to be less than the limit value for the difference.

11. The method according to claim 9, wherein the limit for the third acceleration value is 0.2 g, the limit value for the lateral acceleration is 0.2 g, and the limit value for the difference is 0.05 g.

12. The method according to claim 1, further comprising:
determining a total acceleration value depending on the first measured acceleration value measured while driving and the second measured acceleration value measured while driving,
determining a correct output of an acceleration amount or value in a direction of a longitudinal acceleration in response to determining that:
the total acceleration value is greater than a limit value for the total acceleration value,
the longitudinal acceleration is greater than a limit value for the longitudinal acceleration, and
a difference between the longitudinal acceleration and the total acceleration value smaller in magnitude than a limit value for the difference.

13. The method according to claim 12, wherein the first and second correct outputs are determined in response to determining that an average of a predetermined number of differences of simultaneously measured longitudinal accelerations and determined total acceleration values while driving is less than the limit value for the difference.

14. The method according to claim 12, wherein the limit value for the total acceleration value is 0.15 g, the limit value for the longitudinal acceleration is 0.15 g, and the limit value for the difference is 0.05 g.

15. The method according to claim 1, further comprising:
determining a total acceleration value depending on the first measured acceleration value measured while driving and the second measured acceleration value measured while driving;
determining a vehicle longitudinal acceleration depending on a speed of the vehicle; and
determining a correct output of the total acceleration from the first and second measured acceleration values in response to determining that:
the total acceleration value is greater than a limit value for the total acceleration value,
the vehicle longitudinal acceleration is greater than a limit value for the vehicle longitudinal acceleration, and
a difference between the vehicle longitudinal acceleration and the total acceleration value is smaller in magnitude than a limit value for the difference.

16. The method according to claim 15, wherein the first correct output and the second correct output are determined in response to determining that an average of a predetermined number of differences of simultaneously occurring vehicle accelerations and total acceleration values while driving is less than the limit value for the difference.

17. The method according to claim 15, wherein the limit value for the total acceleration value is 0.1 g, the limit value for the vehicle longitudinal acceleration is 0.1 g, and the limit value for the difference is 0.05 g.

18. A device for checking an accelerometer in a steering system, the steering system including an electromechanical steering actuator that has an accelerometer, and the accelerometer is configured to measure a first acceleration value on a first axis, a second acceleration value on a second axis, and a third acceleration value on a third axis, the first, second, and third axes being perpendicular to each other, and wherein the device is configured to perform the method of claim 1.

19. A vehicle, comprising:
a steering system comprising an electromechanical steering actuator, the electromechanical steering actuator comprising an accelerometer configured to measure a first acceleration value on a first axis, a second acceleration value on a second axis, and a third acceleration value on a third axis, the first, second, and third axes being perpendicular to each other; and
a device configured to determine whether the vehicle is stationary or driving and, while stationary, determine a first correct output of the first acceleration value, a second correct output of the second acceleration value, and a third correct output of the third acceleration value depending on the first acceleration value measured by the accelerometer while stationary, the second acceleration value measured by the accelerometer while stationary, and the third acceleration value measured by the accelerometer while stationary.
